(19) United States
(12) Patent Application Publication
(10) Pub. No.: US 2006/0070826 A1
(43) Pub. Date: Apr. 6, 2006

(54) Washer for drum brake assembly

(75) Inventor: Gerald Joseph Thibeault, Brampton (CA)

Correspondence Address: VOLPE AND KOENIG, P.C., UNITED PLAZA, SUITE 1600, 30 SOUTH 17TH STREET, PHILADELPHIA, PA, 19103, US

(73) Assignee: METALMADE INC., Brampton (CA)

(21) Appl. No.: 11/007,997

(22) Filed: Dec. 9, 2004

Related U.S. Application Data
(63) Continuation-in-part of application No. 10/957,768, filed on Oct. 4, 2004, now abandoned.

(51) Int. Cl. F16D 55/00

(52) U.S. Cl. 188/71.1

(57) ABSTRACT

The present invention provides a washer for a vehicle drum brake having an S-cam assembly and an axle spider comprising a receiving surface comprising two generally parallel walls merging with a tapering portion having two opposed walls inclining towards one another, the tapering portion merging with a concavely arcuate portion; and a mounting portion having a plurality of attachment points adapted for attaching the washer to the axle spider. The present invention also provides a drum brake having a brake shoe, an S-cam assembly comprising an S-cam attached to a cam shaft, and an axle spider having a cam shaft supporting sleeve, the improvement comprising the provision of a washer having an opening on one side for receiving the cam shaft supporting sleeve of the axle spider and a plurality of attachment points for attaching the washer to the axle spider, wherein the washer is adapted to prevent engagement of the brake shoe with the axle spider.

### FIELD OF INVENTION

The present invention relates to washers for use with brakes assemblies of heavy duty vehicles, in particular S-cam brake assemblies.

### BACKGROUND

Heavy duty brake assemblies typically used on commercial vehicles commonly incorporate a pair of opposing arcuate brake shoes. The brake shoes may be actuated by an actuating member such as an S-cam manipulated by a pneumatic cylinder to force the brake shoes into an engagement with the interior surface of a brake drum.

Most premature brake drum and brake shoe cracking can be attributed to brake drag caused by brake shoe hang up on cam washers or on axle spiders. Prior art cam washers such as washer 26, as shown in FIG. 2, have been employed to help alleviate the problem of brake drag. Typically these washers are mounted about the cam shaft and prevent frictional contact between the cam and the axle spider. However, these washers tend to be easily deformed and are subject to fatigue and failure and as a result have a short lifespan which limits their usefulness.

### SUMMARY OF THE INVENTION

The present invention is a washer adapted for mounting to an axle spider of a S-cam type brake assembly for use in the prevention of brake shoe hang up.

According to a first aspect of the invention, there is provided a washer for a vehicle drum brake having an S-cam assembly and an axle spider comprising: a receiving surface comprising two generally parallel walls merging with a tapering portion having two opposed walls inclining towards one another, said tapering portion merging with a concavely arcuate portion; and a mounting portion having a plurality of attachment points adapted for attaching the washer to the axle spider.

According to a second aspect of the invention, there is provided in a drum brake having a brake shoe, an S-cam assembly comprising an S-cam attached to a cam shaft, and an axle spider having a cam shaft supporting sleeve, the improvement comprising the provision of a washer having an opening on one side for receiving the cam shaft supporting sleeve of the axle spider and a plurality of attachment points for attaching the washer to the axle spider, wherein said washer is adapted to prevent engagement of the brake shoe with the axle spider.

### BRIEF DESCRIPTION OF THE DRAWINGS

Preferred embodiments of the invention will now be described, by way of example, with reference to the accompanying drawings in which:

FIG. 1 is a cut away view of a prior art brake assembly;

FIG. 2 is an exploded view of a prior art brake assembly having a cam washer;

FIG. 3 is an exploded view of a brake assembly with a washer, according to an embodiment of the invention;

FIG. 4 is an exploded view of a brake assembly with the washer, according to an embodiment of the invention attached to the axle spider;

FIG. 5a is a top plan view of a washer according to an embodiment of the invention;

FIG. 5b is a side view of a washer according to an embodiment of the invention;

FIG. 6a is a top plan view of a washer according to a further embodiment of the invention;

FIG. 6b is a side view of a washer according to a further embodiment of the invention;

FIG. 7 is a top, partial view of a washer according to an embodiment of the invention attached to an axle spider; and

FIG. 8 is a top, exploded view of a washer according to a still further embodiment of the invention.

Similar numerals refer to similar parts throughout the drawings.

### DETAILED DESCRIPTION

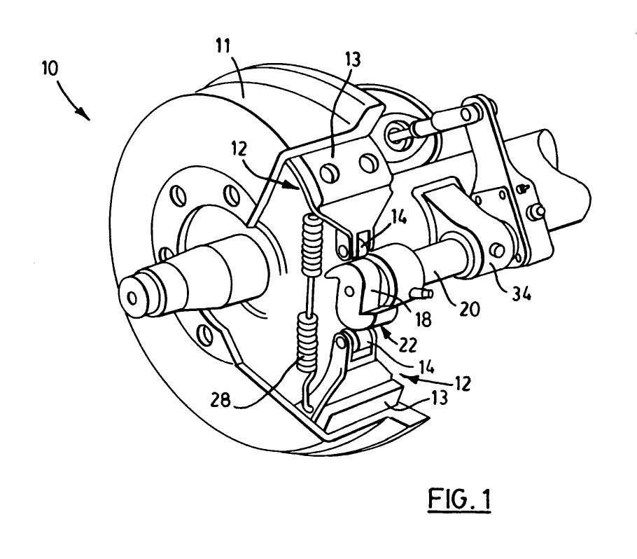

As seen in FIG. 1, a typical vehicle drum brake assembly 10 comprises a drum 11, upper and lower brake shoes 12 and a S-cam assembly 16. The S-cam assembly 16 causes the brake shoes 12 to pivot about pivot points (not seen in FIG. 1) to move brake pads 13 into contact with an inner portion or braking surface on the drum 11.

Two cam rollers 14 are provided, each one at an end of the brake shoes 12. The cam rollers 14 are supported on the end of the brake shoes 12.

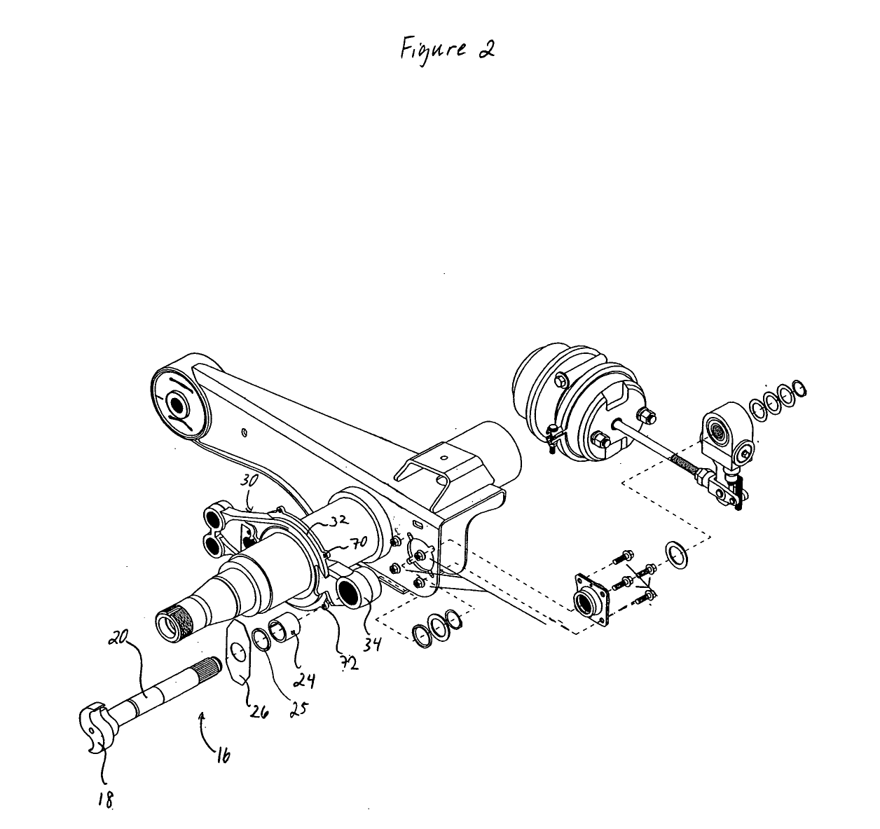

FIG. 2 illustrates a typical S-cam assembly 16 comprising an S-shaped cam 18 attached to a cam shaft 20. The cam shaft 20 is threaded through a bushing 24 and the shaft 20 is supported by an axle spider 30. A cam washer 26 is positioned between the S-cam 18 and the axle spider 30.

During brake operation, when the cam shaft 20 is rotated in the conventional manner, the attached S-shaped cam 18 pivots such that the camming surface 22 bears against the cam rollers 14 to cause the brake shoes 14 to pivot about the pivot points against the bias of a spring 28 (see FIG. 1). The same spring 28 biases the rollers 14 against the camming surface. This movement forces the brake pads 13 into contact with the inwardly facing surface of the brake drum 11. When the brakes are released, the brake shoes 12 and brake pads 13 are withdrawn from contact with the brake drum surface by the return spring 28.

Brake hang up occurs when the brake shoes 12 become lodged either on the cam washers 26 or the axle spider 30, especially the portion of the axle spider 30 adjacent to the S-cam bushing 24. As a result, the brakes are not properly applied or released. Brake hang up reduces the life of the brake shoes and the brake drums. Continual application of the brake shoes as result of hang up can cause overheating and uneven and excessive wear which eventually necessitates replacement of the either the brake drum, brake shoes or both, due to cracking. Overheating of the brake drum can also lead to wheel seal failure. Brake hang up and subsequent brake malfunction, can also causes tire damage such as flat spotting.

The present invention provides a simple and inexpensive solution to the problems associated with brake hang up or brake drag discussed above. The present invention further solves the problem of fatigue and failure associated with conventional cam washers.

In one aspect, the present invention provides a drum brake having a brake shoe, an S-cam assembly comprising an S-cam attached to a cam shaft, said cam shaft supported by an axle spider; and a cam washer provided between the S-cam and the axle spider, the improvement comprising the provision of a washer having an opening on one side for receiving the S-cam assembly and the axle spider and a plurality of attachment points for attaching the washer to the axle spider, wherein said washer is adapted to prevent engagement of the brake shoe with the cam washer and the axle spider. In a further aspect, the present invention further provides a washer for a vehicle drum brake having an S-cam assembly and an axle spider.

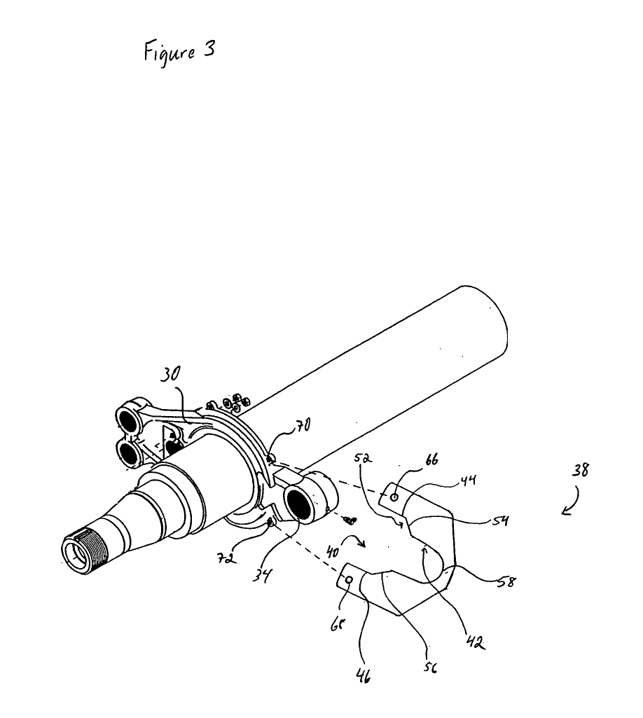

Reference is now made to FIG. 3. The washer 38 according to the present invention is a generally C shaped plate, having an opening 40 on one side for receiving an S-cam assembly 18 and an axle spider 30. The washer 38 is typically formed from a hardened metal. The washer 38 is preferably comprised of steel, and more particularly powder-coated steel. The washer 38 according to the invention can be manufactured using any suitable metal stamping method known in the art and can be manufactured from a unitary piece of metal. Alternatively, as described later, the washer 38 can be assembled from a plurality of metal pieces which are welded together and then powder-coated.

In the present invention, prior art cam washer 26, if present, is removed and replaced with a smaller, for example annular, cam washer 36. Cam washer 36 protects the axle spider 30, the cam seal 25, and the cam bushing 24 from abrasion caused by rotation of the S-cam 16.

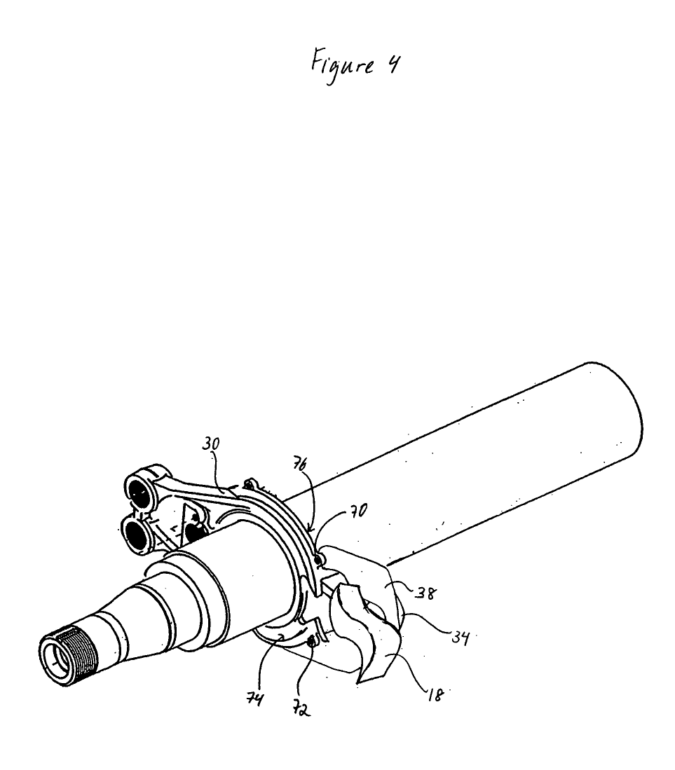

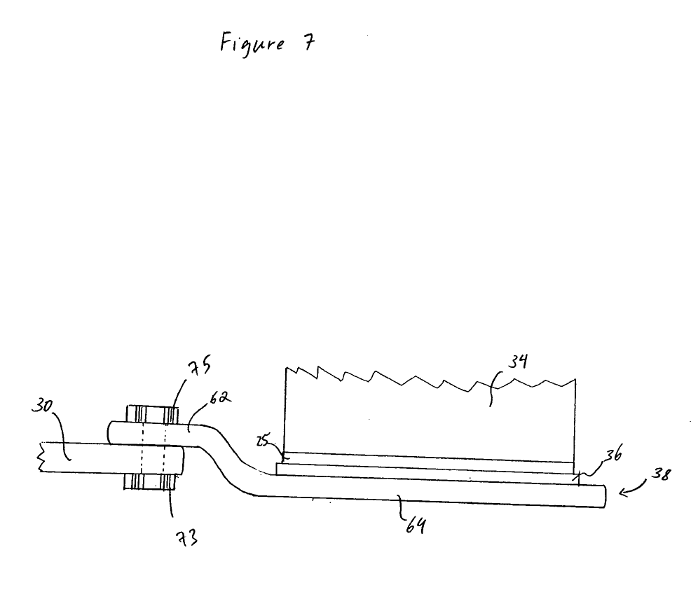

Washer 38 is shaped and sized for mounting around the cam shaft bushing 24 with its inner face (inwardly of the vehicle) bearing against smaller cam washer 36. As seen in FIG. 7, smaller cam washer 36 engages cam seal 25, which in turn engages a cylindrical sleeve 34 that receives bushing 24. The washer 38 functions as a guard and prevents brake hang up by providing a barrier between the brake shoes and the axle spider 30 and the cam washer 36. In use, the washer 38 prevents the brake shoes 12, which have a tendency to slide laterally, from catching on the axle spider 30 or on the cam washer 36. When the washer 38 is properly positioned about the cam shaft bushing 24 and axle spider 30 as shown in FIG. 4, it does not obstruct or interfere with any other component of a typical brake assembly. The washer can be employed in conjunction with or without generally available dust covers.

The washer 38 comprises a receiving surface 42 which in a preferred form comprises two generally parallel walls members 44, 46 which merge with a tapering portion 52 comprising two opposed walls 54, 56 which incline towards one another. The tapering portion 52 merges with a concavely arcuate portion. The profile of the receiving surface 42 is adapted to correspond to the profile of the S-cam shaft 20 and to receive with clearance the portions of the axle spider 30 on which it is to be mounted. The concavely arcuate portion 58 of the washer 38 is sized and configured to allow the shaft 20 to pass through with clearance. The tapering portion 52 of the washer is sized and configured to pass over the contours of the cam supporting sleeve 34 of the axle spider 30.

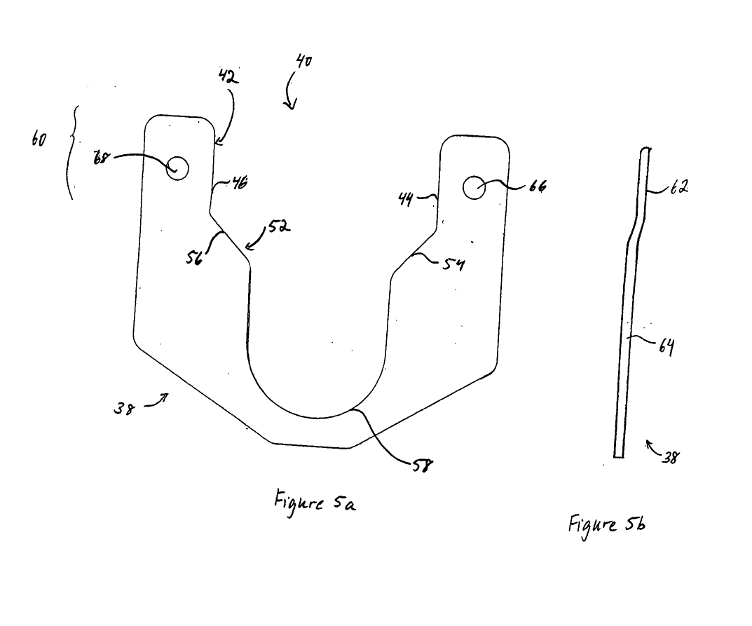

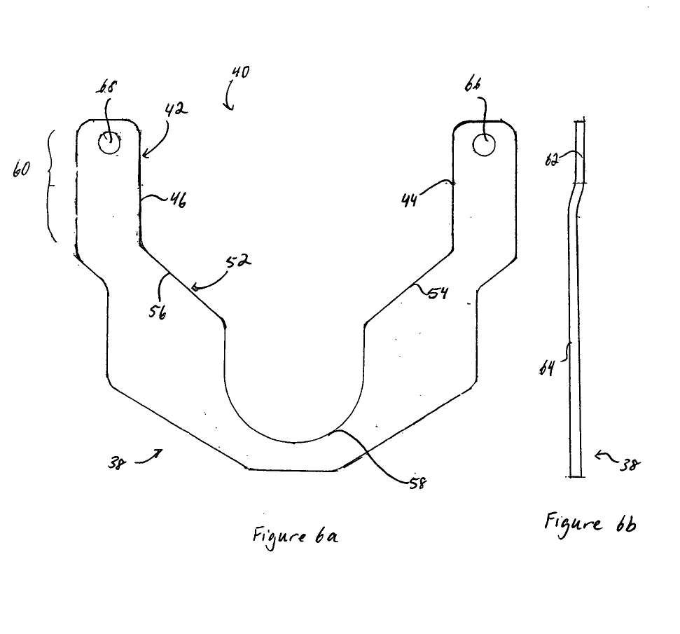

As depicted in FIGS. 5a and 5b, the washer 38 can be sized and configured for use with trailer brakes employing Dana D22 type axles. As shown in FIGS. 6a and 6b, the washer 38 can be also be sized and configured for use with an Eaton drive axle or a Dana trailer axle. It will be appreciated that any of the dimensions of the washer 38 may be adjusted to accommodate any sized brake axle.

As shown in FIGS. 3, 4, 5a, 5b, 6a, and 6b, the washer 38 comprises mounting portions 60 having a plurality of attachment points 66 and 68 adapted for attaching the washer 38 to the axle spider 30. In a preferred embodiment, the attachment points 66, 68 are openings in the mounting portions 60. As seen in FIG. 3, the axle spider 30 has a plurality of openings about the circumference of the main body 32 of the axle spider 30 which may conventionally be used for the attachment of a dust cover. Typically, an axle spider 30 has two openings 70, 72 adjacent to the cam supporting sleeve 34 of the axle spider 30. The spacing of the openings 66, 68 is the same as the spacing of openings 70, 72 so that openings 66, 68 can be aligned in register with the openings 70, 72 for use in mounting the washer 38 to the axle spider 30 as seen in FIGS. 3 and 4. The openings 66, 68 are preferably adapted for use with a threaded fastener such as a nut 73 and a bolt 75 as shown in FIG. 7. In use, the washer 38 is positioned around the cam supporting sleeve 34 of the axle spider 30 as shown in FIG. 4.

As shown in FIGS. 5a, 5b,6a and 6b, in the preferred form, the mounting portions 60 of the washer 68 each include a planar portion 62 adapted to engage the attachment points of the axle spider 70, 72. Each of said portions 62 is offset from a main planar portion 64 of the washer 38.

As shown in FIG. 7, in use, the washer 38 is mounted such that main portion 64 of the wall members 44, 46 bears against cam washer 36. The extent of the offset between portions 64 and 62 will depend on the distance between the front face 74 and back face 76 of the axle spider 30 on which the washer 38 is to be mounted.

This arrangement allows for secure attachment of the washer 38 to the brake assembly. When the nut 73 and bolt 75 are tightened up, the washer 38 is flexed resiliently as the main portion 64 is displaced resiliently outwardly by its reaction with the cam washer 36. As a result, there is a resilient reaction causing main portion 64 to bear compressively and resiliently on cam washer 36 such that washer 38 tends to be maintained firmly in place as a result of the friction between the portion 64 and cam washer 38. As such, movement of the washer 38 relative to the axle spider 30 during brake operation is substantially prevented.

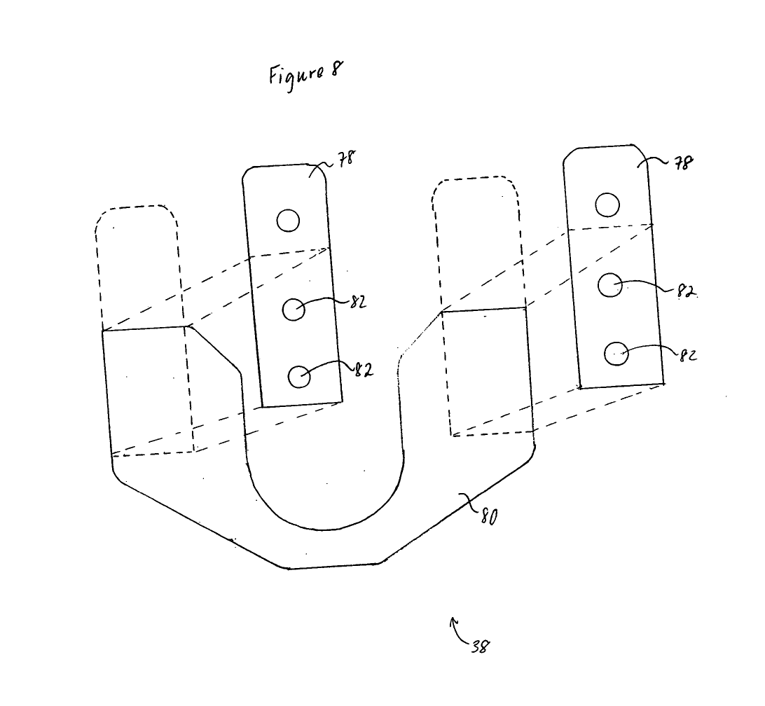

While FIGS. 5a, 5b, 6a and 6b show washers 38 formed from unitary pieces of metal, the washer 38 may be formed from a plurality of pieces of metal which are connected together, for example by welding. As shown in FIG. 8, the washer 38 may comprise a pair of generally rectangular members 78 and a bridging member 80. Each of the generally rectangular members 78 have a plurality of plug weld holes 82 for use in plug-welding the generally rectangular members 78 to the bridging member 80 by conventional welding means. In a preferred form, the members 78 are non-planar and are approximately S-shaped in longitudinal cross-section to provide the offset described above with reference to FIG. 7.

As shown in FIG. 2, conventional cam washers 26 are mounted around the cam shaft 20 and held in place between the S-cam 18 and the axle spider 30 by frictional force. As prior art washers are not secured into place, they can rotate about the cam shaft thereby reducing their effectiveness in preventing brake hang up. Furthermore, such movement increases the chance of damage to the washer. As such, even under normal use conditions, prior art washers have a very limited useful lifetime as they tend to be thin and easily bent and broken.

In comparison, the washer 38 according to the present invention is securable to an axle spider and as such is substantially more resistant to deformation and breakage. Movement of the washer in response to applied force is restricted. By securing the washer to the axle spider, any force applied to the washer is substantially transferred to the axle spider. The general C-shape of the washers allows for even distribution of applied force throughout the washer and to the axle spider. Thus, the washer according to the present invention is superior to prior art washers in terms of effectiveness in preventing brake hang up and in terms of durability. This arrangement is advantageous as it maximizes the load bearing properties of the washer.

Although the invention has been described with reference to illustrative embodiments, it is understood that the invention is not limited to these precise embodiments, and that various changes and modifications may be effected therein by one skilled in the art. All such changes and modifications are intended to be encompassed in the appended claims.

1. A washer for a vehicle drum brake having an S-cam assembly and an axle spider comprising:
a receiving surface comprising two generally parallel walls merging with a tapering portion having two opposed walls inclining towards one another, said tapering portion merging with a concavely arcuate portion; and
a mounting portion having a plurality of attachment points adapted for attaching the washer to the axle spider.

2. The washer according to claim 1 wherein, said axle spider comprises a cam shaft supporting sleeve and wherein said receiving surface is sized and configured to receive the cam shaft.

3. The washer according to claim 1, wherein the attachment points are openings defined by the mounting portion, said openings adapted for receiving a fastener.

4. The washer according to claim 3, wherein the fastener is a threaded fastener.

5. The washer according to claim 3, wherein the axle spider has attachment points for receiving a fastener and wherein the attachment points of the washer are spaced to be alignable with the attachment points of the axle spider.

6. The washer according to claim 1, wherein the axle spider has an outwardly directed face and an oppositely directed face and the mounting portion of the washer comprises a main planar portion and an offset planar portion, wherein the main planar portion is adapted to engage the outwardly directed face of the axle spider and the offset planar portion is adapted to engage the oppositely directed face of the axle spider.

7. The washer according to claim 1, wherein the washer is comprised of steel.

8. The washer according to claim 7, wherein the steel is powder-coated

9. The washer according to claim 1, wherein the receiving surface and the mounting portion are integrally connected.

10. The washer according to claim 1, wherein the mounting portion comprises a generally rectangular member; the parallel walls, tapering portion and a arcuate portion of the receiving surface defines a bridge member; and wherein the generally rectangular member is securably attached the bridge member.

11. The washer according to claim 10, wherein the generally rectangular member defines at least one plug weld opening, and wherein the generally rectangular member is securably attached to the parallel wall of the bridge member by welding.

12. In a drum brake having a brake shoe, an S-cam assembly comprising an S-cam attached to a cam shaft, and an axle spider having a cam shaft supporting sleeve, the improvement comprising the provision of a washer having an opening on one side for receiving the cam shaft and a plurality of attachment points for attaching the washer to the axle spider, wherein said washer is adapted to prevent engagement of the brake shoe with the axle spider.

13. The drum brake according to claim 12, wherein the washer comprises a receiving surface comprising two generally parallel walls merging with a tapering portion having two opposed walls inclining towards one another, said tapering portion merging with a concavely arcuate portion; and a mounting portion having a plurality of attachment points adapted for attaching the washer to the axle spider.

14. The drum brake according to claim 13, wherein the attachment points of the washer are openings defined by the mounting portion, said openings adapted for receiving a fastener.

15. The drum brake according to claim 14, wherein the fastener is a threaded fastener.

16. The drum brake according to claim 12, wherein the axle spider has attachment points for receiving a fastener and wherein the attachment points of the washer are aligned with the attachment points of the axle spider.

17. The drum brake according to claim 12, wherein the mounting portion of the washer comprises a main planar portion and an offset planar portion wherein the main planar portion engages an outwardly directed face of the axle spider and the offset planar portion engages an oppositely directed face of the axle spider.

18. The drum brake according to claim 17, wherein the main planar portion is displaced resiliently outwardly and bears compressively on the outwardly directed face of the axle spider.

19. The drum brake according to claim 12, wherein the washer is comprised of steel.

20. The drum brake according to claim 19, wherein the steel is powder-coated.

21. The washer according to claim 12, wherein the receiving surface and the mounting portion are integrally connected.

22. The washer according to claim 21, wherein the mounting portion comprises a generally rectangular member; the parallel walls, tapering portion and arcuate portion of the receiving surface defines a bridge member; and wherein the generally rectangular member is securably attached the bridge member.

23. The washer according to claim 22, wherein the generally rectangular member defines at least one plug weld opening, and wherein the generally rectangular member is securably attached to the parallel wall of the bridge member by welding.
